(19) United States
(12) Patent Application Publication
(10) Pub. No.: US 2025/0280811 A1
(43) Pub. Date: Sep. 11, 2025

(54) ICE FISHING HOLE COVER APPARATUS

(71) Applicant: GRAYDEN OUTDOOR, LLC, BRAINERD, MN (US)

(72) Inventor: TREVOR J SUMPTION, BRAINERD, MN (US)

(73) Assignee: GRAYDEN OUTDOOR, LLC, BRAINERD, MN (US)

(21) Appl. No.: 18/597,306

(22) Filed: Mar. 6, 2024

(51) Int. Cl. A01K 97/01

(52) U.S. Cl. CPC A01K 97/01

(57) ABSTRACT

An ice fishing hole cover apparatus comprising a flange securable to a floor surface of a floor surrounding a floor hole with a sleeve extending from the flange into the floor hole and defining an aperture therethrough. A cover configured to biasingly magnetically engage the flange using several magnets and several corresponding metal elements disposed around the cover and around the flange respectively. The ice fishing hole cover apparatus may include an insert insertable into the sleeve in mechanical cooperation with the sleeve detent to extend the aperture to the ice fishing hole.

### BACKGROUND OF THE INVENTION

### Field

This disclosure relates to apparatus for ice fishing, and, more specifically, to ice fishing hole cover apparatus for selective covering of an ice fishing hole within an ice fishing house.

### Background

Ice fish houses have been long used for fishing through the ice of, for example, a frozen lake or river. The ice fishing house includes a floor through which one or more floor holes are provided. The fisherman may then access the ice through the floor hole(s) in order to drill ice fishing hole(s) through the ice and then fish therethrough. Fishing may be performed, for example, by angling or by spearing through the ice fishing hole, in various aspects.

It may be important to seal a region around the ice fishing hole including the floor hole when not in use to inhibit refreezing of the ice fishing hole thereby making it easier to redrill the ice fishing hole at a later time. Prevention of snow, dirt, and debris from blowing through the floor hole and onto the ice and/or into the ice fishing hole by sealing the floor hole(s) may eliminate a nuisance. Sealing the floor hole may eliminate a hazard e.g., prevents stepping into the hole when walking about the floor of the ice fish house. Improved esthetics around the floor hole are also a consideration. Sealing the gap between the floor and the ice around the floor hole may prevent wind from blowing via the gap into the ice fishing house through the floor hole. Accordingly, there is a need for improved apparatus as well as related methods for covering selectively an ice fishing hole within an ice fishing house.

### BRIEF SUMMARY OF THE INVENTION

These and other needs and disadvantages may be overcome by the apparatus and related methods of use disclosed herein. Additional improvements and advantages may be recognized by those of ordinary skill in the art upon study of the present disclosure.

An ice fishing hole cover apparatus is disclosed herein. In various aspects, the ice fishing hole cover apparatus includes a base ring having a flange securable to a floor surface of a floor surrounding a floor hole with a sleeve extending from the flange into the floor hole and defining a base ring aperture therethrough. A cover is configured to biasingly magnetically engage the flange using several magnets and several corresponding metal elements disposed around the cover and around the flange respectively to selectively cover the base ring aperture. The ice fishing hole cover apparatus may include an insert insertable into the sleeve in mechanical cooperation with the sleeve detent to extend the aperture to the ice fishing hole. The cover may include a cover insert extending forth from a cover side of the cover, and the cover insert is insertable into the base ring aperture. In various aspects, the cover insert defines an outer boundary having a frustoconical shape configured to guide the cover flange into biased engagement with the recessed surface of the flange by insertion of the cover insert into the base ring aperture.

This summary is presented to provide a basic understanding of some aspects of the apparatus and methods disclosed herein as a prelude to the detailed description that follows below. Accordingly, this summary is not intended to identify key elements of the apparatus and methods disclosed herein or to delineate the scope thereof.

### BRIEF DESCRIPTION OF THE DRAWINGS

FIG. 1A illustrates by perspective view an exemplary implementation of ice fishing hole cover apparatus according to the present inventions;

FIG. 1B illustrates by plan view the exemplary ice fishing hole cover apparatus of FIG. 1;

FIG. 2 illustrates by exploded perspective view the exemplary ice fishing hole cover apparatus of FIG. 1A;

FIG. 3A illustrates by cross-sectional elevation view portions of the exemplary ice fishing hole cover apparatus of FIG. 1A;

FIG. 3B illustrates by cross-sectional elevation view portions of the exemplary ice fishing hole cover apparatus of FIG. 1A; and,

FIG. 4 illustrates the exemplary ice fishing hole cover apparatus of FIG. 1A by cross-sectional elevation view through cutline 4-4 of FIG. 1B.

The Figures are exemplary only, and the implementations illustrated therein are selected to facilitate explanation. The number, position, relationship and dimensions of the elements shown in the Figures to form the various implementations described herein, as well as dimensions and dimensional proportions to conform to specific force, weight, strength, flow and similar requirements are explained herein or are understandable to a person of ordinary skill in the art upon study of this disclosure. Where used in the various Figures, the same numerals designate the same or similar elements. Furthermore, when the terms “top,” “bottom,” “right,” “left,” “forward,” “rear,” “first,” “second,” “inside,” “outside,” and similar terms are used, the terms should be understood in reference to the orientation of the implementations shown in the drawings and are utilized to facilitate description thereof. Use herein of relative terms such as generally, about, approximately, essentially, may be indicative of engineering, manufacturing, or scientific tolerances such as ±0.1%, ±1%, ±2.5%, ±5%, or other such tolerances, as would be recognized by those of ordinary skill in the art upon study of this disclosure.

### DETAILED DESCRIPTION OF THE INVENTION

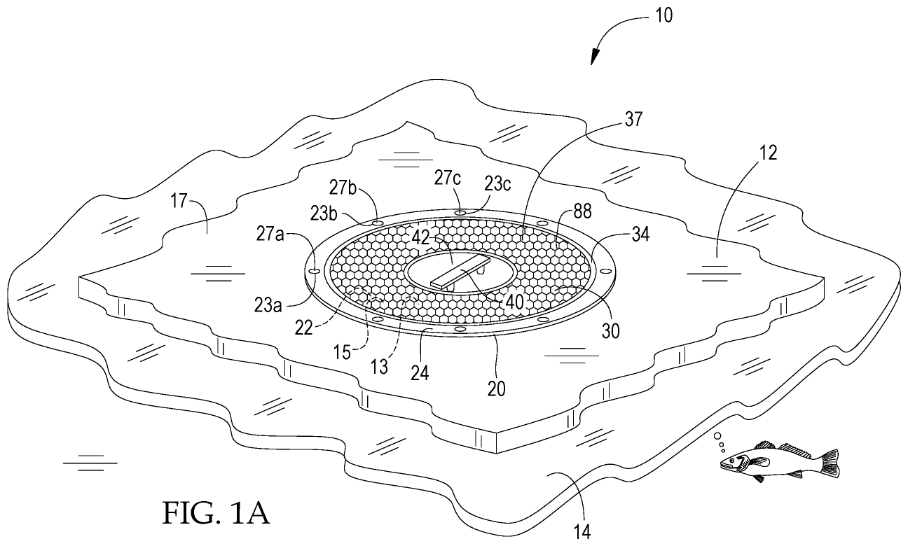

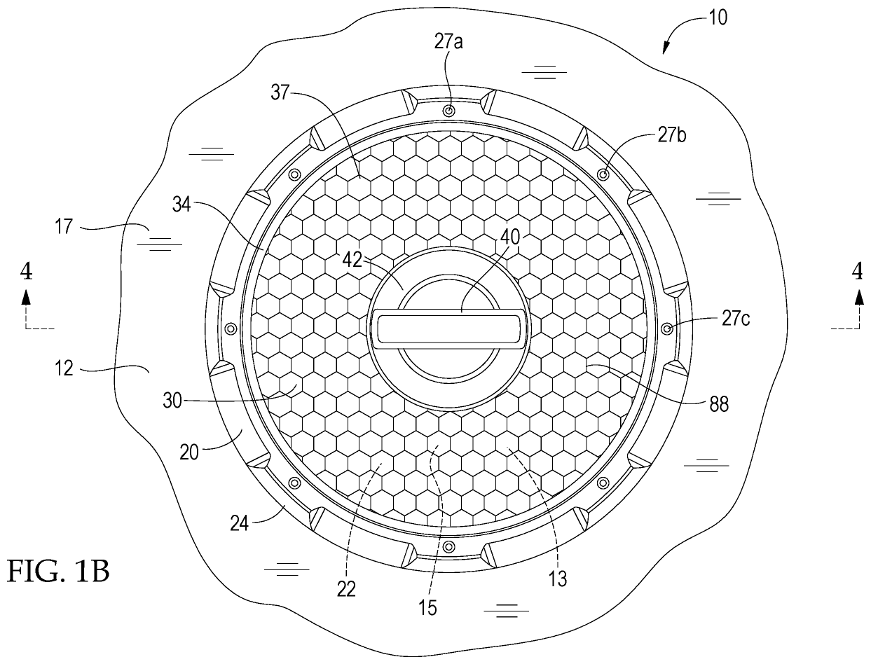

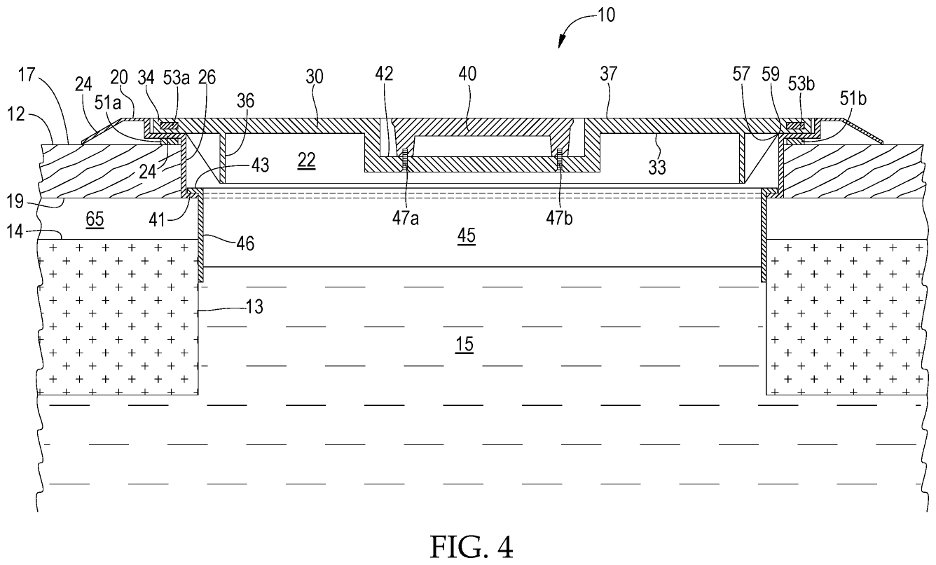

As illustrated in FIGS. 1A, 1B, exemplary ice fishing hole cover apparatus 10 includes cover 30 removably received by base ring 20. Base ring 20, as illustrated, is received partly within floor hole 13 formed in floor 12 with base ring 20 generally engaging floor 12 around a periphery of floor hole 13. Fasteners, such as fasteners 27a, 27b, 27c, engage base ring 20 and engage floor surface 17 of floor 12 through holes, such as holes 23a, 23b, 23c, respectively, disposed circumferentially around base ring 20 to secure base ring 20 to floor 12, as illustrated. Base ring 20 defines base ring aperture 22 that allows communication through floor hole 13, in this implementation. Floor 12 may comprise a portion of a structure used for ice fishing (e.g., an ice fishing house), so that floor 12 may be generally enclosed within the structure. Floor 12 may be formed out of lumber or plywood, for example. As illustrated, floor 12 overlies ice 14, and base ring aperture 22 received by floor hole 13 aligns with an ice fishing hole 15 (also see FIG. 4) passing through ice 14 to allow fishing therethrough by a fisherman positioned above floor surface 17 of floor 12. Ice fishing hole 15 may be formed by chisel or ice auger through base ring aperture 22.

Cover 30, as illustrated in FIGS. 1A, 1B, is removably received by base ring 20 to enclose selectively base ring aperture 22 thereby to enclose selectively floor hole 13 and portions of ice 14 beneath floor 12 including ice fishing hole 15. When received by base ring 20, cover side 37 of cover 30 as well as base ring 20 are generally flush with or low profile with respect to floor surface 17 of floor 12 so as not to form an obstruction about floor 12. Tread 88 is configured in portions of cover side 37 of cover 30 to provides traction to a user walking upon floor surface 17 of floor 12 thereby preventing slipping on cover 30 when cover 30 is received by base ring 20. Handle 40 is received in recess 42 formed in cover 30 to allow a user to manipulate cover 30 in order to engage cover 30 with base ring 20 or remove cover 30 from engagement with base ring 20. By being received in recess 42, handle 40 avoids obstructing cover side 37 of cover 30 and, thus, floor surface 17 of floor 12. Note that, while base ring 20, base ring aperture 22 and cover 30 have a circular shape in exemplary ice fishing hole cover apparatus 10, base ring 20, base ring aperture 22, and cover 30 may assume other shapes such as oval, rectangular, or square, compatible with one another, in various other implementations. Base ring 20 and cover 30 may be generally formed of suitable injection molded plastic, as would be readily recognized by those of ordinary skill in the art upon study of this disclosure. In certain implementations, cover 30 may be configured to be insulating, and, thus, may include, for example, foam plastic, and may have sufficient thickness to provide insulation, as would be readily recognized by those of ordinary skill in the art upon study of this disclosure.

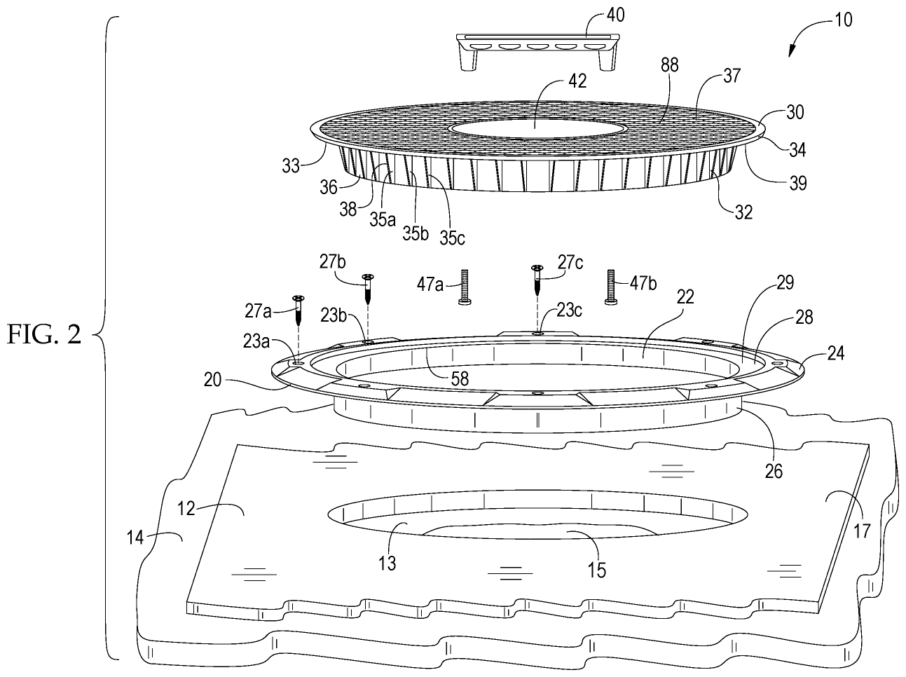

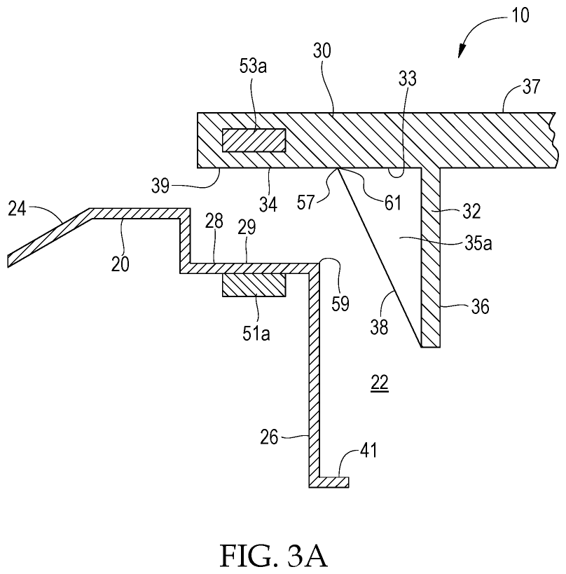

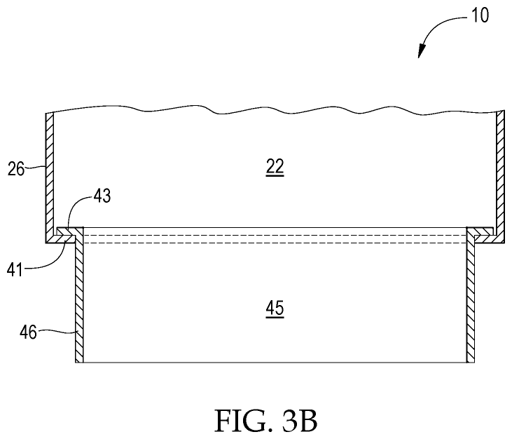

As illustrated in FIG. 2, base ring 20 includes sleeve 26 and flange 24. Sleeve 26 extends forth from flange 24 and is inserted into floor hole 13 in disposition generally around the periphery of floor hole 13 with flange 24 overlying floor surface 17 of floor 12, as illustrated. At least portions of sleeve 26 may bias against the periphery of floor hole 13 in certain implementations. Thus, sleeve 26 bounds portions of base ring aperture 22 with other portions of base ring aperture 22 being bounded by flange 24, in this implementation. Flange 24 of base ring 20 may be secured to floor surface 17 of floor 12 by fasteners, such as fasteners 27a, 27b, 27c, through holes, such as holes 23a, 23b, 23c, respectively, provided circumferentially around flange 24. Flange 24 includes recessed portion 28 with recessed surface 29 that is formed around an entire inner periphery thereof, and cover 30 includes cover flange 34 formed around an entire outer periphery thereof, as illustrated. Recessed surface 29 of recessed portion 28 is configured to receive cover flange surface 39 of cover flange 34 around an entire outer periphery of cover 30 in biased engagement when cover 30 is engaged with base ring 20, as illustrated in FIG. 2 and FIG. 3A.

As illustrated in FIG. 2, cover 30 includes cover insert 32 that extends forth from cover side 33 of cover 30 with cover side 33 being opposite of cover side 37. Cover insert 32 includes barrel 36 with plates, such as plates 35a, 35b, 35c, disposed peripherally with edges of the plates in radial alignment and axial alignment around barrel 36, as illustrated in FIGS. 2, 3A. The plates are triangular in shape, as illustrated in FIG. 3A, so that edges of the plates define outer boundary 38 of cover insert 32 having a frustoconical shape broadest at cover side 33. Vertexes of the planar triangular shaped plates, such as vertex 61 of plate 35a illustrated in FIG. 3A, define an inner boundary 57 of cover flange surface 39 of cover flange 34, which is an outer portion of cover side 33. The plates secured to barrel 36 as per exemplary ice fishing hole cover apparatus 10 may structurally support cover 30 without the material and associated weight of a similarly shaped structure of continuous solid construction. When received in the base ring aperture 22, the plates contact the base ring 20 which may support structurally the base ring 20 cover 30 combination in engagement with floor 12. The frustoconical shape of cover insert 32 may guide the insertion of cover insert 32 into base ring aperture 22, and the frustoconical shape of cover insert 32 may aid in aligning cover 30 with base ring 20 including the alignment of cover flange surface 39 of cover flange 34 with recessed surface 29 of recessed portion 28 of base ring 20. For example, portions of frustoconical shaped outer boundary 38 of cover insert 32 may variously bias against portions of the sleeve 26 causing repositioning of the cover 30 as the cover insert 32 is being inserted into the sleeve 26 resulting in alignment of the cover flange surface 39 of the cover flange 34 of the cover 30 with the recessed surface 29 of the recessed portion 28 of the base ring 20 when cover insert 32 is fully received. This may be useful, for example, in low light conditions to ensure proper engagement between the base ring 20 and cover 30. When fully received in base ring aperture 22, cover insert 32 extends into base ring aperture 22 with barrel 36 generally parallel to sleeve 26, and plates, such as plates 35a, 35b, 35c, proximate vertices, such as vertex 61, biased against edge 59 of recessed portion 28 of base ring 20 to align the cover flange surface 39 of the cover flange 34 of the cover 30 in biased engagement with the recessed surface 29 of the recessed portion 28 of base ring 20, in this implementation.

Handle 40 is illustrated in FIG. 2 as being secured to cover 30 using fasteners 47a, 47b (also see FIG. 4). Handle 40 may be hingedly secured to cover 30 to be selectively positioned, in various other implementations. Handle 40 may telescopically receive itself to be selectively extended/retracted, in yet other implementations.

As illustrated in FIG. 3A and FIG. 4, magnets, such as magnets 51a, 51b, are disposed around an entirety of recessed portion 28 of base ring 20 to engage magnetically corresponding metal elements, such as metal elements 53a, 53b, disposed around an entirety of cover flange 34 of cover 30 to hold the entirety of cover flange surface 39 of cover flange 34 engaged with the entirety of recessed surface 29 of recessed portion 28 of base ring 20. Thus, the entire periphery of cover flange 34 of cover 20 and the entire periphery of recessed portion 28 of base ring 20 are magnetically engaged with one another, not just at certain mechanical detents at certain specific locations. Such magnetic engagement of the entirety of cover flange surface 39 of cover 30 with the entirety of recessed surface 29 of base ring 20 may thus sealingly engage cover 30 with base ring 20 thereby sealing floor hole 13 and ice 14 beneath floor 12 including ice fishing hole 15 passing through ice 14. Such peripheral sealing between cover 30 and base ring 20 may inhibit refreezing of ice fishing hole 15 and may keep snow, dirt, etc. from floor hole 13, ice 14 beneath floor 12, and ice fishing hole 15. Although only magnets 51a, 51b and corresponding metal elements 53a, 53b are illustrated in FIG. 3A and FIG. 4 for explanatory purposes, it should be understood that many magnets, such as magnets 52a, 52b, and corresponding metal elements, such as metal elements 53a, 53b, may be disposed peripherally at regular intervals around recessed portion 28 and cover flange surface 39, in various implementations. For example, the number of magnets, such as magnets 51a, 51b, may be generally between about 4 magnets and about 12 magnets with a corresponding number of metal elements, such as metal elements 53a, 53b. In yet other implementations, the magnet and corresponding metal element may be configured as a continuous strip disposed around the circumference of base ring 20 and cover 30, respectively.

The metal elements, such as metal elements 53a, 53b, are magnetically attracted to the magnets, such as magnets 51a, 51b, in this implementation. In other implementations, magnets, such as magnets 51a, 51b, may be disposed peripherally at regular intervals around cover flange 34 of cover 30, and metal elements, such as metal elements 53a, 53b, may be disposed peripherally at regular intervals around recessed portion 28 of base ring 20. Magnets of opposite polarity may be disposed peripherally around cover flange 34 of cover 30 and peripherally around recessed portion 28 of base ring 20 to engage magnetically cover 30 with base ring 20, in certain implementations. In exemplary ice fishing hole cover apparatus 10, magnets, such as magnets 51a, 51b, are illustrated as disposed between recessed portion 28 of flange 24 and floor 12, and metal elements, such as metal elements 53a, 53b, are illustrated as embedded within cover flange 34 of cover 30. However, it should be recognized that magnets and/or metal elements may be variously disposed about recessed portion 28 of flange 24 and cover flange 34 of cover 30 in various other ways, in various other implementations.

As illustrated in FIGS. 3A, 3B, 4, exemplary ice fishing hole cover apparatus 10 may include insert 46 having a cylindrical shape and defining insert passage 45 therethrough. Sleeve 26 of base ring 20 includes sleeve detent 41 configured as a lip that extends peripherally around sleeve 26, and insert 46 includes insert detent 43 configured as a lip that extends peripherally around insert 46, as illustrated. Insert 46 may be insertably removably held within sleeve 26 by engagement between sleeve detent 41 and insert detent 43, as illustrated in FIG. 3B and FIG. 4. Note that insert 46 is sized to pass into base ring aperture 22 at flange 24 with flange 24 engaged with floor 12 in order to engage insert detent 43 with sleeve detent 41. It should also be recognized that insert 46 may have other shapes in conformance to other shapes of sleeve 26, in various other implementations. Also note that structure(s) other than insert 46 may be configured to engage sleeve detent 41, in various other implementations. Further note that several inserts, such as insert 46, may be configured to engage telescopically one another and be held extended by insert detents, such as insert detents 43, formed at the ends thereof, in various other implementations.

The ice fishing house may rest upon supports (not shown) such as dimensional lumber (e.g., 2×4, 4×4, etc.), various blocks, bricks, etc., so that there is generally a gap 65 between floor surface 19 of floor 12 and ice 14, as illustrated in FIG. 4. For example, water may flow onto ice 14 from cracks and heaves in ice 14. Gap 65 between floor surface 19 of floor 12 and ice 14 may prevent such water flows onto ice 14 from flooding floor 12 and from freezing floor 12 into ice 14, both of which are highly undesirable. However, gap 65 provides a pathway for the communication of wind through floor hole 13. As illustrated in FIG. 4, insert 46 extends from sleeve 26 of base ring 20 into ice fishing hole 15 around a periphery thereof in order to block wind communication through floor hole 13 via gap 65. Ice fishing hole 15 may then be accessed through base ring aperture 22 and through insert passage 45 with base ring aperture 22 and insert passage 45 being generally in alignment. Accordingly, insert 46 effectively extends base ring aperture 22 to ice fishing hole 15. In this implementation, lengths of sleeve 26 and cover insert 32 are configured to allow insert 46 to remain engaged with sleeve 26 whether or not cover 30 is received by base ring 20. FIG. 4 illustrates insert 46 engaged with sleeve 26 and cover 30 received by base ring 20. Note that a water surface of water within ice fishing hole 15 lies slightly below an ice surface of ice 14, as illustrated in FIG. 4.

As use and operation of the exemplary ice fishing hole cover apparatus 10 is readily recognizable to those of ordinary skill in the art upon study of this disclosure, no further discussion of the use or operation of the exemplary ice fishing hole cover apparatus 10 is provided.

The foregoing discussion along with the Figures discloses and describes various exemplary implementations. These implementations are not meant to limit the scope of coverage, but, instead, to assist in understanding the context of the language used in this specification and in the claims. The Abstract is presented to meet requirements of 37 C.F.R. § 1.72 (b) only. Accordingly, the Abstract is not intended to identify key elements of the apparatus and methods disclosed herein or to delineate the scope thereof. Upon study of this disclosure and the exemplary implementations herein, one of ordinary skill in the art may readily recognize that various changes, modifications and variations can be made thereto without departing from the spirit and scope of the inventions as defined in the following claims.

The invention claimed is:

1. An ice fishing hole cover apparatus, comprising:
a base ring defining a base ring aperture and comprising a flange securable to a floor surface of a floor surrounding a floor hole formed in the floor by a plurality of fasteners and with a sleeve surrounding the base ring aperture at the flange extending from the flange into the floor hole;
a recessed portion comprising an innermost portion of the flange, the recessed portion passing around an entire periphery of the base ring aperture and defining a recessed surface;
a cover having a cover flange passing around an entirety of an outermost periphery of the cover and defining a cover flange surface, the cover flange surface configured to biasingly engage a recessed surface of the recessed portion of the flange; and
several magnets and several corresponding metal elements for disposition around the cover flange of the cover and around the recessed portion of the base ring to hold magnetically an entirety of the cover flange surface in biased engagement with an entirety of the recessed surface.

2. The apparatus of claim 1, further comprising:
a cover insert extending forth from a cover side of the cover and forming an inner boundary of the cover flange surface, the cover insert being insertable into the base ring aperture, the cover insert defining an outer boundary having a frustoconical shape configured to guide the cover flange surface of the cover flange into biased engagement with the recessed surface of the flange by insertion of the cover insert into the base ring aperture.

3. The apparatus of claim 2, further comprising:
a plurality of plates of planar triangular shape in planar radially aligned disposition around an outer surface of a barrel to form the cover insert with sides of the plates defining the outer boundary, vertexes of the plates at the outer boundary and the cover side define the inner boundary of the cover flange of the cover, the vertexes engage an edge of the recessed portion of the flange to align the cover flange surface in biased engagement with the recessed surface.

4. The apparatus of claim 1, further comprising:
a sleeve detent formed at a sleeve end of the sleeve opposite the sleeve end of the sleeve attached to the flange.

5. The apparatus of claim 4, further comprising:
an insert insertable into the sleeve, the insert configured to mechanically cooperate with the sleeve detent and to extend the base ring aperture to an ice fishing hole.

6. The apparatus of claim 1, further comprising:
a handle in recessed disposition about a cover surface of the cover.

7. The apparatus of claim 1, further comprising:
a tread formed in a cover surface of the cover.

8. An ice fishing hole cover apparatus, comprising:
a base ring defining a base ring aperture and comprising a flange secured to a floor surface of a floor surrounding a floor hole formed in the floor by a plurality of fasteners and with a sleeve surrounding the base ring aperture at the flange extending from the flange into the floor hole;
a recessed portion comprising an innermost portion of the flange, the recessed portion passing around an entire periphery of the base ring aperture and defining a recessed surface;
a cover having a cover flange passing around an entirety of an outermost periphery of the cover and defining a cover flange surface, the cover flange surface configured to biasingly engage a recessed surface of the recessed portion of the flange; and
several magnets and several corresponding metal elements disposed around the cover flange of the cover and around the recessed portion of the flange to hold magnetically an entirety of the cover flange surface in biased engagement with an entirety of the recessed surface.

9. The apparatus of claim 8, further comprising:
a cover insert extending forth from a cover side of the cover and forming an inner boundary of the cover flange surface, the cover insert being insertable into the base ring aperture, the cover insert defining an outer boundary having a frustoconical shape configured to guide the cover flange surface of the cover flange into biased engagement with the recessed surface of the flange by insertion of the cover insert into the base ring aperture.

10. The apparatus of claim 8, further comprising:
an insert inserted into the sleeve in mechanically cooperation with the sleeve detent to extend the base ring aperture to an ice fishing hole.
